(19) United States
(12) Patent Application Publication
(10) Pub. No.: US 2011/0004652 A1
(43) Pub. Date: Jan. 6, 2011

(54) METHOD AND SYSTEM FOR ENABLING A USER TO VOTE ON A PORTION OF AN IMAGE AND FOR DISPLAYING THE IMAGE

(75) Inventor: James A. Long, Santa Monica, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/496,315

(22) Filed: Jul. 1, 2009

(51) Int. Cl. G06F 15/16

(52) U.S. Cl. 709/203

(57) ABSTRACT

A server computer transmits a web page over a network to a computing device so that the web page can be displayed by a browser operating on the computing device. The web page includes an image. The server computer then receives, from the computing device, coordinates of a portion of the image, the portion of the image selected by a user of the computing device. After receiving the coordinates, the server computer transmits to the computing device an updated image for display via the browser. Portions of the updated image have different levels of opacity that depend on the number of times the selected portion and other portions have been selected by other users to which the image is made available, so that the user can visually determine from the updated image portions of the updated image that have been selected by the user and by other users.

### FIELD

The present disclosure relates to images and, more specifically, to enabling a user to vote on a portion of an image and for displaying the image.

### BACKGROUND

Web pages often contain different types of information, such as text, images, and video. Sometimes, the company which has produced the web pages is interested in the popularity of one or more items or people in one or more of the images displayed in the web pages. For example, people may be interested in the popularity of different outfits worn by different celebrities during an awards show, such as the Oscars®. Sometimes the popularity information is gathered for entertainment, while other times companies such as clothing companies may be interested in these popularity statistics in order to determine or adjust their next clothing lines.

### SUMMARY

The present disclosure relates to enabling a user to vote and/or comment on one or more portions of an image. The number of votes that a portion of an image receives can correlate with, for example, its popularity.

In one aspect, a server computer transmits a web page over a network to a computing device so that the web page can be displayed by a browser operating on the computing device. The web page includes an image. The server computer then receives, over the network from the computing device, coordinates of a portion of the image, the portion of the image selected by a user of the computing device. After receiving the coordinates of the selected portion, the server computer transmits, over the network and to the computing device, an updated image for display via the browser. Portions of the updated image have different levels of opacity that depend on the number of times the selected portion and other portions have been selected by other users to which the image is made available, so that the user can visually determine from the updated image portions of the updated image that have been selected by the user and by other users.

In one embodiment, the server computer transmits a client side software module to the computing device. The client side software module generates the coordinates of the selected portion. In one embodiment, the server computer receives a comment associated with the selected portion of the image from the computing device. In one embodiment, the server computer transmits one or more comments over the network to the computing device, where each comment is associated with a portion of the updated image. The computing device then displays the comment(s).

In another aspect, a server computer transmits a web page over a network to a computing device so that the web page can be displayed by a browser operating on the computing device. The web page includes an image. The server computer then receives, over the network from the computing device, coordinates of a portion of the image, the portion of the image selected by a user of the computing device. After receiving the coordinates of the selected portion, the server computer transmits, over the network and to the computing device, an updated image for display via the browser. Portions of the updated image have different characteristics that depend on the number of times the selected portion and other portions have been selected by other users to which the image is made available, so that the user can visually determine from the updated image portions of the updated image that have been selected by the user and by other users.

Examples of the different characteristics include different borders around different portions of the image and different numbers on different portions of the image. In one embodiment, a key is displayed corresponding to the different numbers and the number of times the selected portion and the other portions have been selected.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram of a computing device communicating with a server over a network in accordance with an embodiment of the present disclosure;

FIG. 2 is a flowchart illustrating the steps performed by the server of FIG. 1 to enable a user of the computing device to vote on one or more portions of an image displayed on a web page in accordance with an embodiment of the present disclosure;

FIG. 3 is a screen shot displayed by the computing device in which a user can vote on their favorite cast member in the television show Baywatch in accordance with an embodiment of the present disclosure;

FIG. 4 is a screen shot displayed by the computing device in which different portions of an image are displayed with different levels of opacity in accordance with an embodiment of the present disclosure;

FIG. 5 is a screen shot displayed by the computing device that lists comments that users have added in accordance with an embodiment of the present disclosure;

FIG. 6 is a screen shot displayed by the computing device illustrating a selection box inside an image in accordance with an embodiment of the present disclosure;

FIG. 7 is a screen shot displayed by the computing device containing an image in which different portions have different levels of opacity corresponding to the number of votes associated with each portion of the image in accordance with an embodiment of the present disclosure; and

FIG. 8 is a high level block diagram of a computing device in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the invention that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

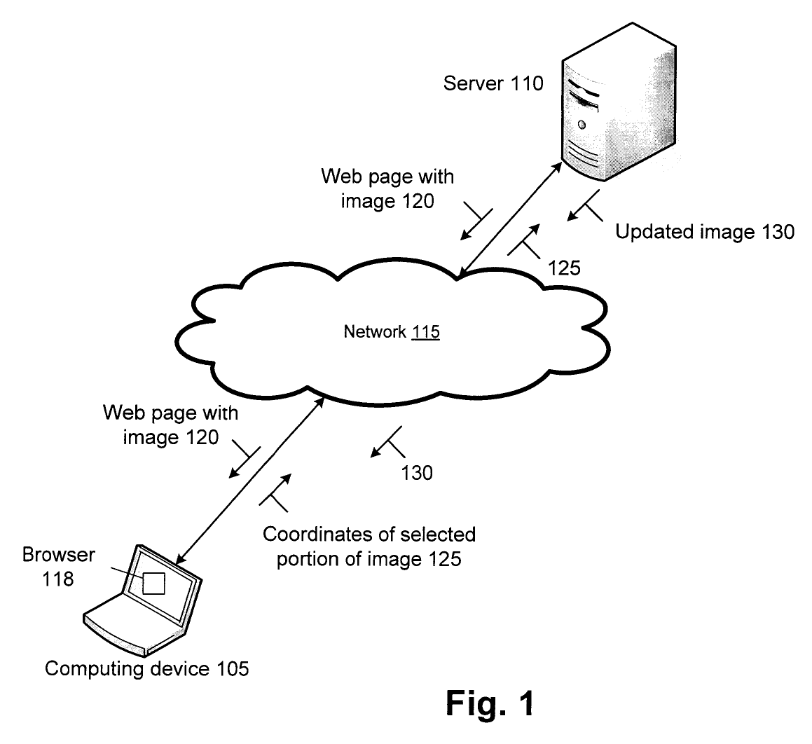

FIG. 1 shows a block diagram of an embodiment of a system 100 having a computing device 105 in communication with a server 110 over a network 115. A user of the computing device 105 uses a browser 118 to request a particular web page from the server 110. Server 110 transmits a web page 120 containing one or more images over the network 115 to the computing device 105. The browser 118 displays the web page 120 with the one or more images to the user. The user can then vote for one or more portions of an image on the web page 120. In particular, the web page 120 enables the user to select a portion of an image using a selection box. In one embodiment, the browser 118 contains a client side software module which is used to generate the coordinates of the selection box after the user uses the selection box to select a portion of the image. In one embodiment, the server 110 transmits the client side software module to the computing device 105 as part of the web page 120. Alternatively, the server 110 previously transmitted the client side software module to the computing device 105. In another embodiment, the browser 118 itself contains this client side software module.

The user selects a portion of the image on the web page 120 and the client side software module generates the coordinates of this selection box. These coordinates are the coordinates of the selection box relative to a designated point in the web page 120 (e.g., the top left corner of the web page 120). The computing device 105 then transmits the coordinates 125 of the selected portion of the image to the server 110. The server 110 keeps track of the number of votes that the server 110 receives for each set of coordinates 125. As described in more detail below, the server 110 transmits an updated image 130 to the computing device 105. In one embodiment, the server 110 transmits the entire web page again to the computing device 105 with the updated image after receiving coordinates from the computing device 105. In another embodiment, the server 110 transmits only the update image 130 to the computing device 105 for display via the browser 118. As described in more detail below, the update image 130 enables the user to visually determine the portions of the image that have been selected by the user as well as by other users.

For purposes of this disclosure, a computer or computing device such as the computing device 105 and/or server 110 includes a processor and memory for storing and executing program code, data and software which may also be tangibly stored or read from any type or variety of well known computer readable storage media such as magnetic or optical discs, by way of non-limiting example. Computers can be provided with operating systems that allow the execution of software applications in order to manipulate data. Personal computers, personal digital assistants (PDAs), wireless devices, cellular telephones, internet appliances, media players, home theater systems, servers, and media centers are several non-limiting examples of computing devices. The computing device 105 and the server 110 can, in one embodiment, also include a display, such as a screen or monitor.

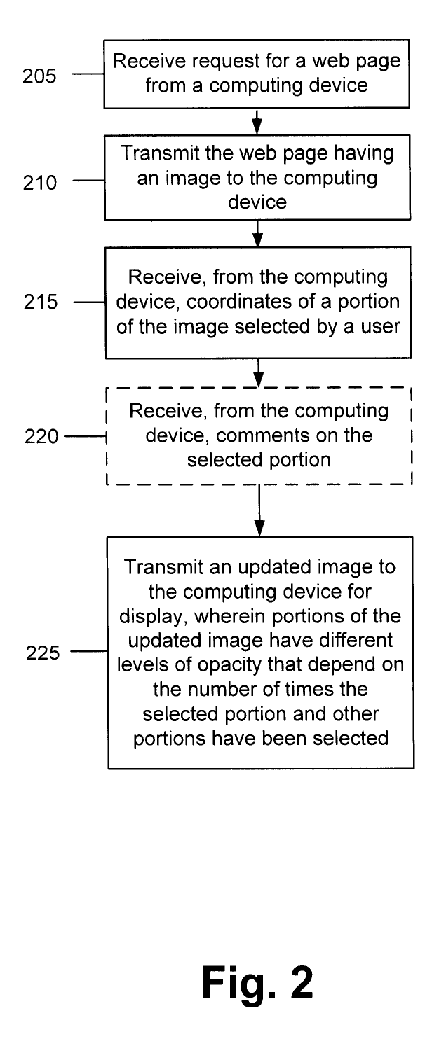

FIG. 2 is a flowchart showing an embodiment of the steps performed by the server 110 to enable the user to visually determine the popularity of different portions of the image. As described above, the server 110 transmits a client side software module to the computing device 105. In another embodiment, the client side software module is downloaded by the computing device 105 from another website. In yet another embodiment, the computing device 105 already stores and executes the client side software module. As described above, the client side software module is adapted to generate coordinates of the portions of an image selected by a user.

Next, the server 110 receives a request for a particular web page from the computing device 105 (step 205). The server 110 transmits web page 120 having an image to the computing device 105 (step 210). In step 215, the server 110 receives from the computing device 105 coordinates of a portion of the image selected by a user of the computing device 105. As described above, the coordinates of the portion of the image are generated by the client side software module. In one embodiment, the client side software module is a Javascript program. In one embodiment, the server 110 receives from the computing device 105 one or more comments on the selected portion of the image (step 220, as shown with a dashed box).

In step 225, the server 110 transmits an updated image 130 to the computing device 105 for display on its browser 118. Different portions of the update image 130 have different levels of opacity that depend on the number of times the selected portion and other portions have been selected. More specifically, this updated image contains different portions and the level of opacity for each portion of the image is based on the number of times that that particular portion has been selected. For example, if a first user selects a first portion of the image and a second user selects a second portion of the image, and the first portion and second portion overlap, the updated image 130 will display the overlapped portion as the darkest portion of the image, the portions of the image that don't overlap (but have been selected) as the second darkest portions, and the portions of the image that were not selected by the first and/or second user as the lightest portions of the image.

As a specific example, suppose an image contains three people—Person 1, Person 2, and Person 3. Further, suppose that the computing device 105 transmits coordinates associated with a selection box around Person 1 and Person 1 has previously been selected by this user and/or by other users three times, Person 2 has been selected two times, and Person 3 has been selected one time. In one embodiment, the updated image 130 displays Person 1 as having two more levels of opacity relative to the opacity of Person 3, and Person 1 as having one more level of opacity relative to the opacity of Person 2. For example, Person 3 may be displayed three times as bright as Person 1, and Person 3 may be displayed twice as bright as Person 2.

This “heatmap” enables a user to visually determine which portions of the updated image 130 have been selected and how many times the portions have been selected relative to other portions in the image 130. Further, in one embodiment, when the updated image 130 is being displayed by the browser 118, the user may see the comments associated with different portions of the updated image 130 by pointing their mouse cursor over the different portions. In one embodiment, a user can hover over a portion of the image 130 to bring that portion forward (full opacity) and/or to see the comment associated with that portion of the image 130.

Although portions of an image that have been voted on are described herein as having different levels of opacity relative to the number of votes the portions have received compared with other portions of the image, any identifying technique can be used. In particular, portions of an image that have been voted on may be displayed with different characteristics depending on the number of votes that each portion has received. For example, if a portion of an image gets the most votes compared with the rest of the image, in one embodiment the updated image surrounds that portion with an identifying border. A portion that receives the next most votes has a different border than the portion with the most votes. In yet another embodiment, the portions can be identified by numbers (e.g., a number in the top left corner of each portion that has received at least one vote) and a key can be displayed that shows the portion number with the corresponding number of votes that the portion has received. Color and/or grey scale changes in the image can also be used.

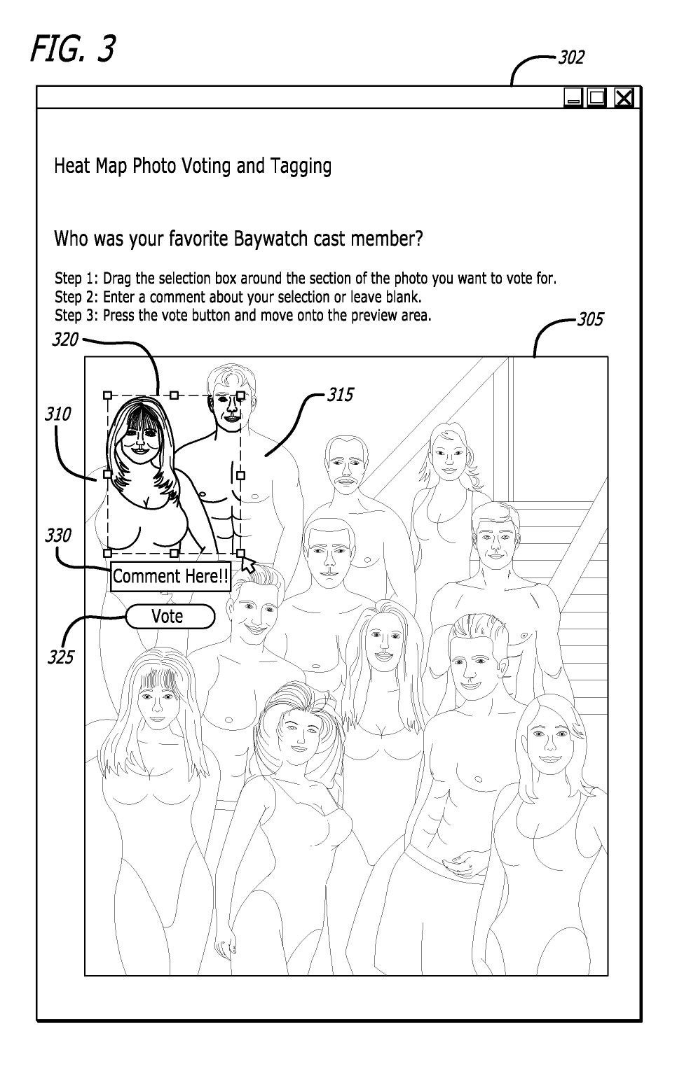

FIG. 3 is an embodiment of a screen shot 302 displayed by the browser 118 in which a user can vote on their favorite cast member in the television show Baywatch. The image 305 includes several Baywatch cast members, such as a first cast member 310 and a second cast member 315. In the screen shot 302, the user uses selection box 320 to select a portion of the image 305. In this example, the user encapsulates a portion of the first cast member 310 and a portion of the second cast member 315 in the selection box 320. The user can resize and/or move the selection box 320 at any time. In one embodiment (and as shown in FIG. 3 with darker lines), the level of opacity of the portion of the image 305 that is encapsulated in the selection box 320 is increased relative to the rest of the image 305. In one embodiment, a voting button 325 and a comment button 330 are located under the selection box 320. After the user has finished moving and/or resizing the selection box 320, the user can press the vote button 325 to vote for the selected portion of the image encapsulated by the selection box 320. As described in more detail below, the user can press the comment button 330 to comment on the portion of the image encapsulated by the selection box 320. It should be noted that several of the figures herein (e.g., FIGS. 3-7) include exemplary instructions, such as instructions for a user to select and/or vote on a portion of an image. These instructions are provided only as examples of instructions for a user.

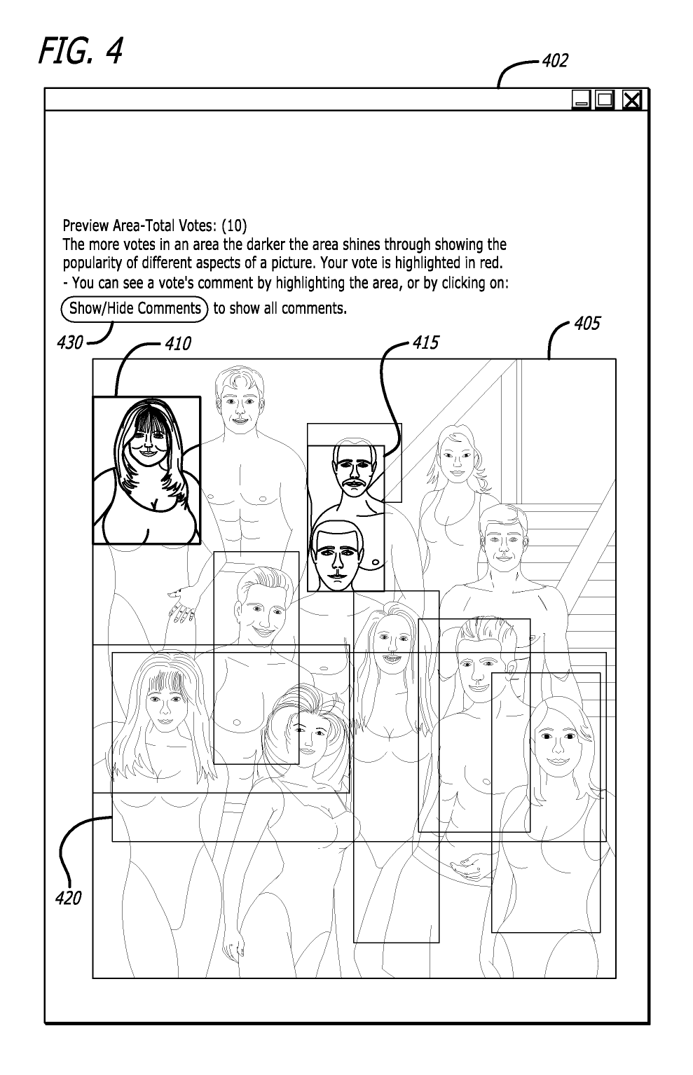

FIG. 4 is an embodiment of a screen shot 402 that illustrates the “heat map” described above (i.e., the updated image 130 of FIG. 1). The updated image 405 shows that a first portion 410 has been voted on the most in the image 405 because the first portion 410 is the darkest portion of the image 405. A second portion 415 has been voted on less than the first portion 410 but more than the other portions of the image 405. This is illustrated in FIG. 4 by the fact that the second portion 415 has darker lines than the rest of the portions of the image 405 but lighter lines than the first portion 410. The rest of the portions, such as third portion 420, have been voted on the least number of times, as shown by the fact that their lines are the lightest compared with the first portion 410 and the second portion 415. For example, the first portion 410 may have been voted on four times, the second portion 415 may have been voted on three times, and the rest of the portions (e.g., the third portion 420) were voted on one time.

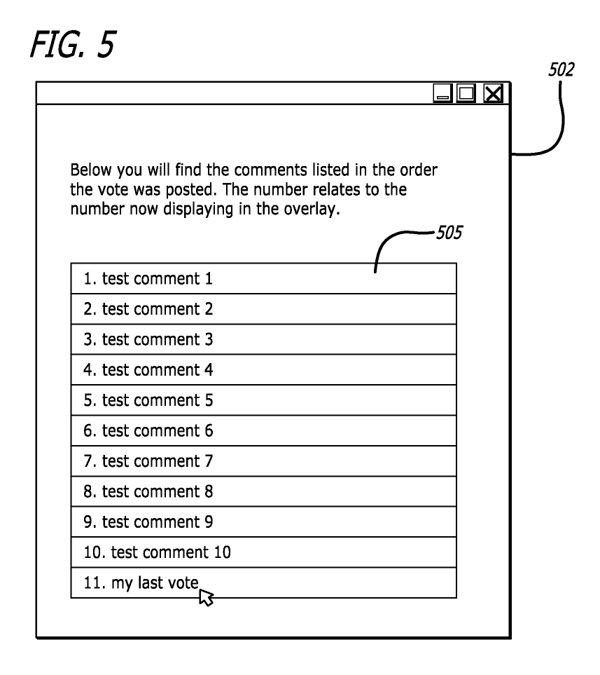

In one embodiment, the screen shot 402 also includes a Show/Hide Comments button 430. If a user clicks on this button 430, comments associated with votes are displayed (e.g., under the respective image portion or in a separate window). For example, suppose a user votes on the first portion 410 as representing their favorite Baywatch cast member. The user also wants to associate a comment with their vote of the first portion 410, such as “test comment 1”. In one embodiment, the user associates a comment with their vote by clicking on the comment button 330 (shown in FIG. 3). In the updated image 405, the user can show (or hide) all of the comments by, for example, clicking on the Show/Hide Comments button 430. FIG. 5 shows an embodiment of a screen shot 502 listing the comments that users have added. In this screen shot 502, the comment associated with the first portion 410, test comment 1, is listed in a first section 505 of the screen shot 502. Other exemplary comments associated with other portions of the image 405 are also listed in screen shot 502.

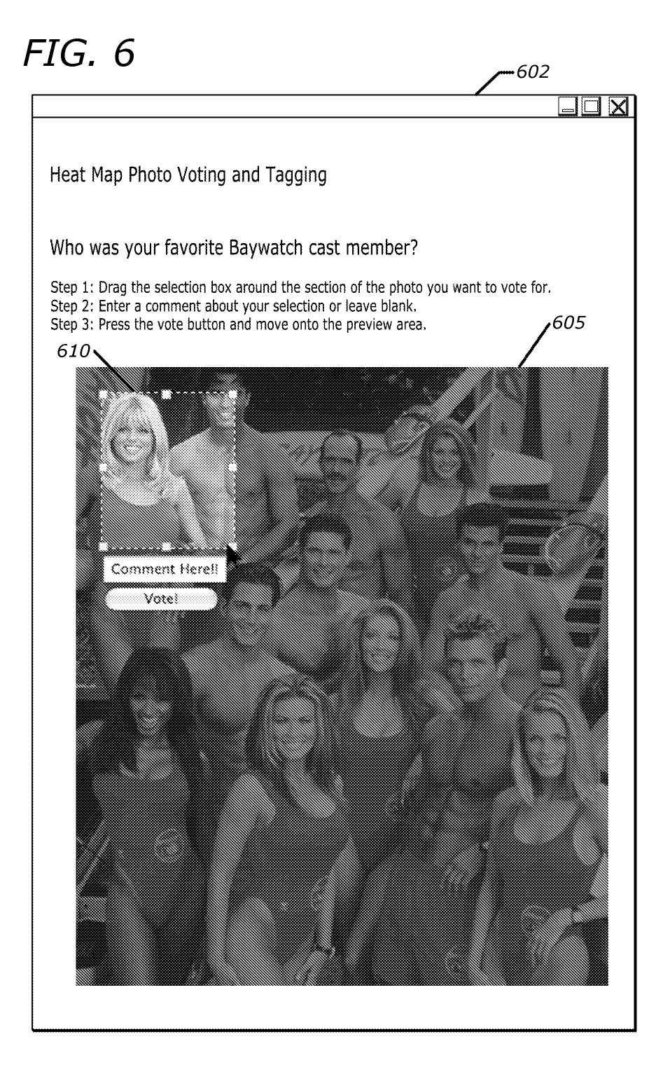

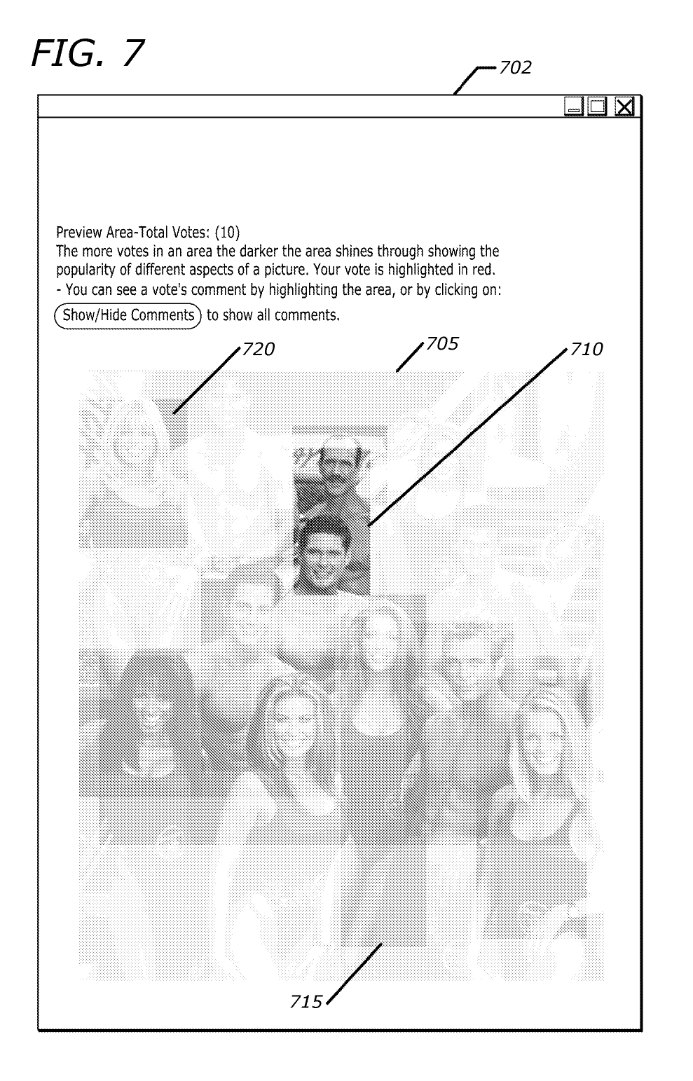

FIG. 6 shows an embodiment of a screen shot 602 illustrating a selection box 610 inside an image 605. FIG. 7 is a screen shot 702 having an image 705 in which different portions of the image 705 have different levels of opacity corresponding to the number of votes associated with each portion. As shown in FIG. 7, image 705 contains a first portion 710, which is the darkest portion of the image 705. Image 705 also includes other portions, such as a second portion 715 and a third portion 720. In image 705, the second portion 715 is darker than the third portion 720, and both portions 715, 720 are lighter than the first portion 710.

Various implementations of the systems and techniques described here can be realized in digital electronic circuitry, integrated circuitry, specially designed ASICs (application-specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device. Such computer programs (also known as programs, software, software applications or code) may include machine instructions for a programmable processor, and may be implemented in any form of programming language, including high-level procedural and/or object-oriented programming languages, and/or in assembly/machine languages. A computer program may be deployed in any form, including as a stand-alone program, or as a module, component, subroutine, or other unit suitable for use in a computing environment. A computer program may be deployed to be executed or interpreted on one computer or on multiple computers at one site, or distributed across multiple sites and interconnected by a communication network.

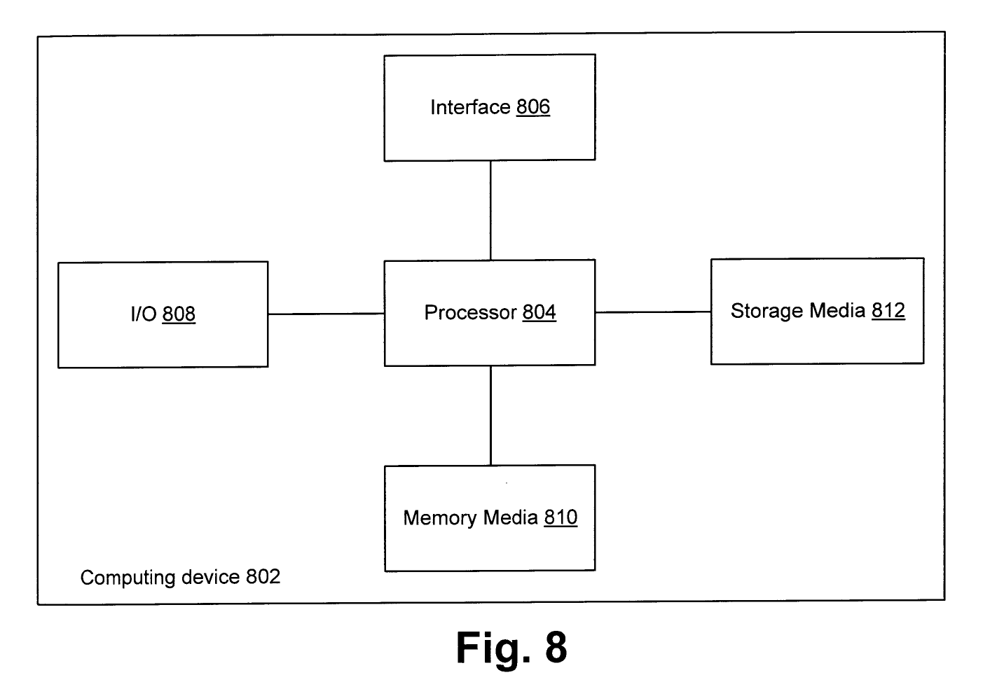

A high level block diagram of a computing device is shown in FIG. 8. Computing device 802 is an example of computing device 105 and/or server 110 of FIG. 1 and contains a processor 804 which controls the overall operation of computing device 802 by executing computer program instructions which define such operation. The computer program instructions can be tangibly stored in a storage media 812 (e.g., magnetic or optical disk or other computer readable medium now known or to become known) and loaded into memory media 810 or read directly from media 810 when execution of the computer program instructions is desired. Computing device 802 also includes one or more interfaces 806 for communicating with other devices (e.g., locally or via a network). Computing device 802 also includes input/output 808 that represent devices that allow for user interaction with the computing device 802 (e.g., display, keyboard, mouse, speakers, buttons, etc.).

One skilled in the art will recognize that an implementation of an actual computing device will contain other components as well, and that FIG. 8 is a high level representation of some of the components of such a computing device for illustrative purposes, which may be, for example, a personal computer, PDA, wireless device, internet appliance, cellular telephone, or such processor driven technology. In addition, the processing steps described herein can also be implemented using dedicated hardware, the circuitry of which is configured specifically for implementing such processing steps. Alternatively, the processing steps can be implemented using various combinations of hardware, firmware and software.

Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the first or second computers or server or both. In this regard, any number of the features of the different embodiments described herein can be combined into single or multiple embodiments, and alternate embodiments having fewer than, or more than, all of the features described herein are possible. Functionality can also be, in whole or in part, distributed among multiple components, in manners now known or to become known. Thus, myriad software/hardware / firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

The foregoing Description is to be understood as being in every respect illustrative and exemplary, but not restrictive, and the scope of the invention disclosed herein is not to be determined from the Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method comprising:
transmitting, by a server computer, a web page over a network to a computing device so that the web page can be displayed by a browser operating on the computing device, the web page comprising an image;
receiving, by the server computer over the network from the computing device, coordinates of a portion of the image, the portion of the image selected by a user of the computing device; and
after receiving the coordinates of the selected portion, transmitting, by the server computer over the network to the computing device, an updated image for display via the browser, wherein portions of the updated image have different levels of opacity that depend on the number of times the selected portion and other portions have been selected by other users to which the image is made available, so that the user can visually determine from the updated image portions of the updated image that have been selected by the user and by other users.

2. The method of claim 1 further comprising transmitting, by the server computer over the network to the computing device, a client side software module adapted to generate the coordinates of the selected portion.

3. The method of claim 1 further comprising receiving, by the server computer over the network from the computing device, a comment associated with the portion of the image.

4. The method of claim 1 further comprising transmitting, by the server computer over the network to the computing device, a list of comments, wherein each comment in the list is associated with a portion of the updated image.

5. The method of claim 1 further comprising transmitting, by the server computer over the network to the computing device, a comment associated with a portion of the updated image.

6. The method of claim 5 further comprising causing the computing device to display the comment.

7. A computer readable medium storing computer program instructions capable of being executed by a computer processor on a computing device, the computer program instructions defining the steps of:
transmitting a web page over a network to a computing device so that the web page can be displayed by a browser operating on the computing device, the web page comprising an image;
receiving, over the network from the computing device, coordinates of a portion of the image, the portion of the image selected by a user of the computing device; and
after receiving the coordinates of the selected portion, transmitting, over the network to the computing device, an updated image for display via the browser, wherein portions of the updated image have different levels of opacity that depend on the number of times the selected portion and other portions have been selected by other users to which the image is made available, so that the user can visually determine from the updated image portions of the updated image that have been selected by the user and by other users.

8. The computer readable medium of claim 7 further comprising transmitting, over the network to the computing device, a client side software module adapted to generate the coordinates of the selected portion.

9. The computer readable medium of claim 8 further comprising receiving, over the network from the computing device, a comment.

10. The computer readable medium of claim 9 further comprising associating the comment with the portion of the image.

11. The computer readable medium of claim 7 further comprising transmitting, over the network to the computing device, a list of comments, wherein each comment in the list is associated with a portion of the updated image.

12. The computer readable medium of claim 7 further comprising transmitting, over the network to the computing device, a comment associated with a portion of the updated image.

13. The computer readable medium of claim 12 further comprising instructions to cause the computing device to display the comment.

14. A method comprising:
transmitting, by a server computer, a web page over a network to a computing device so that the web page can be displayed by a browser operating on the computing device, the web page comprising an image;
receiving, by the server computer over the network from the computing device, coordinates of a portion of the image, the portion of the image selected by a user of the computing device; and
after receiving the coordinates of the selected portion, transmitting, by the server computer over the network to the computing device, an updated image for display via the browser, wherein portions of the updated image have different characteristics that depend on the number of times the selected portion and other portions have been selected by other users to which the image is made available, so that the user can visually determine from the updated image portions of the updated image that have been selected by the user and by other users.

15. The method of claim 14 wherein portions of the updated image having the different characteristics further comprise causing the portions to be displayed with different borders depending on the number of times the selected portion and other portions have been selected.

16. The method of claim 14 wherein portions of the updated image having the different characteristics further comprise causing the portions to be displayed with identifying numbers depending on the number of times the selected portion and other portions have been selected.

17. The method of claim 16 further comprising transmitting, by the server to the computing device, a key corresponding to the identifying numbers and the number of times the selected portion and other portions have been selected.

18. The method of claim 14 further comprising transmitting, by the server computer over the network to the computing device, a client side software module adapted to generate the coordinates of the selected portion.

19. The method of claim 14 further comprising receiving, by the server computer over the network from the computing device, a comment associated with the portion of the image.

20. The method of claim 19 further comprising transmitting, by the server computer over the network to the computing device, the comment for display.
